(19) United States
(12) Patent Application Publication
(10) Pub. No.: US 2007/0222753 A1
(43) Pub. Date: Sep. 27, 2007

(54) Computer mouse

(76) Inventors: Ching-Chiang Yu, Sijhih City (TW); Tien-Hao Yang, Sijhih City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/634,851

(22) Filed: Dec. 7, 2006

(30) Foreign Application Priority Data
Mar. 27, 2006 (TW) 95110492

(51) Int. Cl. G09G 5/08

(52) U.S. Cl. 345/163

(57) ABSTRACT

A computer mouse is provided. The computer mouse includes an upper cover, a scroll wheel module and a supporting component. The scroll wheel module includes at least a scroll wheel, an axle orthogonally installed on and passing through the scroll wheel, and a supporting component installed on an inner surface of the upper cover, and touching and supporting the axle.

### RELATED APPLICATIONS

The present application is based on, and claims priority from, Taiwan Application Serial Number 95110492, filed on Mar. 27, 2006, the disclosure of which is hereby incorporated by reference herein in its entirety.

### BACKGROUND

1. Field of Invention

The present invention relates to a computer mouse. More particularly, the present invention relates to a computer mouse that includes a scroll wheel.

2. Description of Related Art

On the modern market, the scroll wheel has become one of the necessities in the computer mouse. The main function of the scroll wheel is to control the scrolling of the windows in the Windows operating systems. There are two common designs of the scroll wheel: one is the mechanical scroll wheel, accompanying with and driving the mechanical potentiometer in order to get the scrolling information; the other one is the photo-electronic scroll wheel, usually adopting a lattice wheel structure and with an optical sensor installed at the two sides of the bottom of the scroll wheel for receiving the scrolling information.

Please refer to FIG. 1. FIG. 1 is a diagram of the structure inside a conventional computer mouse. As illustrated in FIG. 1, a scroll wheel 10 is supported by a supporting frame 12. The supporting frame 12 is installed on a base 14 of the mouse 1. However, for the more and more functions are required to be integrated within a single electronic device, the number of the electronic components installed on the base 14 of the mouse 1 increases, and thus causes the lack of space on the base 14.

### SUMMARY

The present invention is directed to a computer mouse that utilizing the limited space inside the computer mouse more efficiently.

It is therefore an aspect of the present invention to provide a computer mouse with a supporting frame installed on an inner surface of an upper cover of the computer mouse for touching and fixing an axle of a scroll wheel.

It is another aspect of the present invention to provide a computer mouse that efficiently utilizes the limited space of the mouse and increase the usable space on the base of the mouse.

In accordance with the foregoing and other objectives of the present invention, a computer mouse is provided that includes at least an upper cover and a scroll wheel module. The scroll wheel module includes at least a scroll wheel, an axle orthogonally installed on and passing through the scroll wheel, and a supporting component. The supporting component is installed on an inner surface of the upper cover, and touching and supporting the axle

In the foregoing, it is seen that the supporting frame that is utilized to support the scroll wheel is installed on the inner surface of the upper cover of the mouse in the present invention.

In conclusion, the space on the base of the mouse is saved in the present invention, and the limited space inside the computer mouse can be utilized more efficiently, enabling the installing of other electronic components in accordance.

These and other features, aspects, and advantages of the present invention will become better understood with reference to the following descriptions, figures, and appended claims.

It is to be understood that both the foregoing general description and the following detailed description are by examples, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIG. 1 is a diagram of the inner structure of a computer mouse of the prior art,

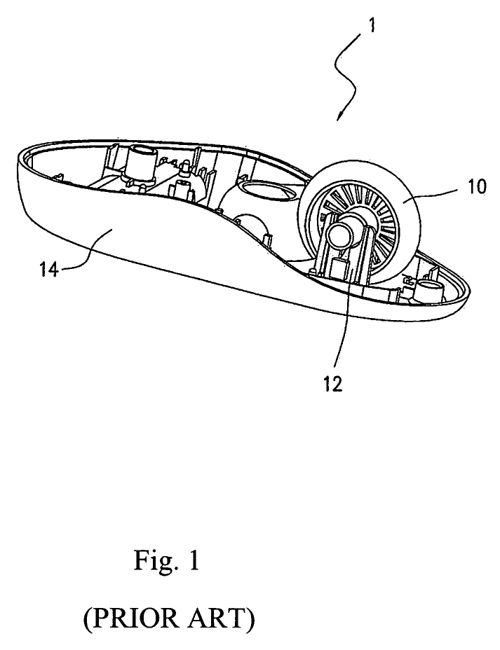

FIG. 2A is a pictorial assembly diagram of an embodiment of the mouse of the present invention,

FIG. 2B is a pictorial decomposition diagram of the mouse shown in FIG. 2A,

FIG. 3A is a pictorial decomposition diagram of another embodiment of the mouse of the present invention,

FIG. 3B is a sectional diagram of the mouse shown in FIG. 3A while the mouse is assembled, and

FIG. 4 is a sectional diagram of the mouse according to still another embodiment of the present invention.

### DESCRIPTION OF THE PREFERRED EMBODIMENTS

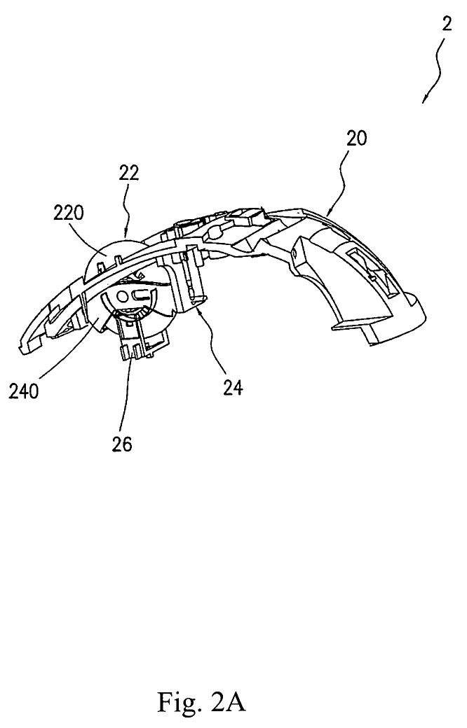

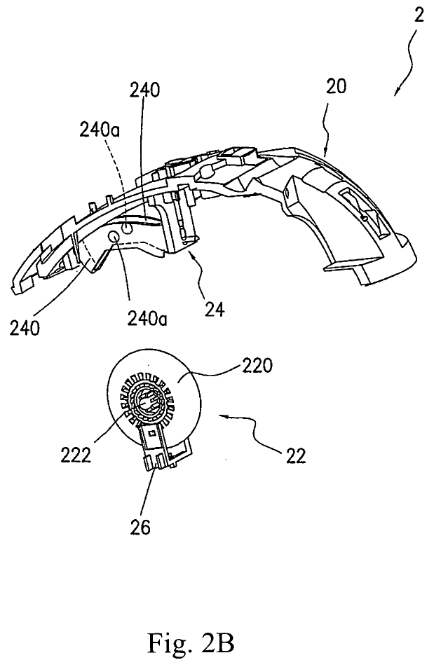

Reference is now made to FIG. 2A and FIG. 2B. FIG. 2A is a pictorial assembly diagram of an embodiment of the mouse 2 of the present invention, and FIG. 2B is a pictorial decomposition diagram of the mouse 2 shown in FIG. 2A. The computer mouse 2 of the present invention includes at least an upper cover 20 and a scroll wheel module 22. The scroll wheel module 22 includes at least a scroll wheel 220 and an axle 222 orthogonally installed on and passing through the scroll wheel 220. The computer mouse 2 of the present invention is characterized by a supporting component 24, installed on an inner surface of the upper cover 20, with the supporting component 24 touching and supporting the axle 222.

As illustrated in FIG. 2B, the supporting component 24 is a supporting frame with two racks 240, hence having a shape of L in the lateral view accordingly. Besides, each of the two racks 240 of the supporting frame includes an opening 240a for an end of the axle 222 to pass through, such that the two racks 240 of the supporting frame can fix and support the two ends of the axle 222 respectively, as displayed in FIG. 2A. Moreover, the computer mouse 2 of the present invention can further includes an optical sensor 26 installed at the two sides of the bottom of the scroll wheel 220, wherein the scroll wheel 220 is a lattice wheel structure as demonstrated in FIG. 2B.

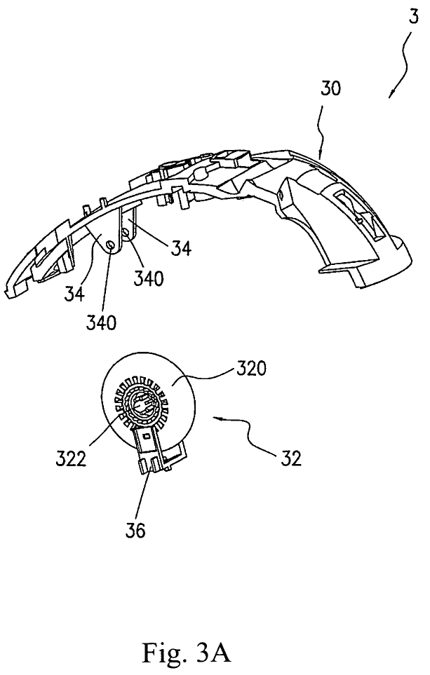

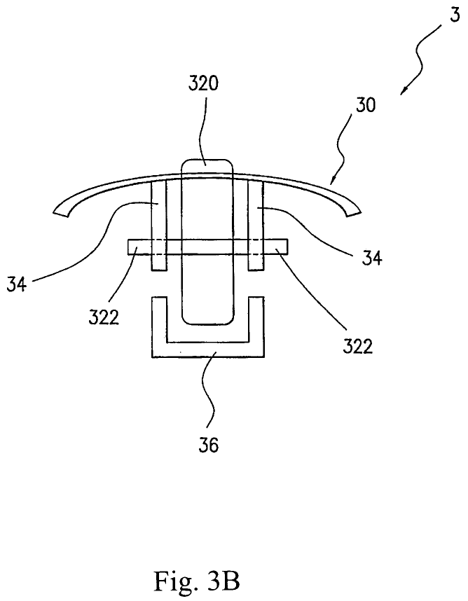

Please refer to FIG. 3A and FIG. 3B. FIG. 3A is a pictorial decomposition diagram of another embodiment of the computer mouse 3 of the present invention, and FIG. 3B is a sectional diagram of the computer mouse 3 shown in FIG. 3A while the computer mouse 3 is assembled. As illustrated in FIG. 3A and FIG. 3B, the computer mouse 3 of the present invention includes at least an upper cover 30 and a scroll wheel module 32. The scroll wheel module 32 includes at least a scroll wheel 320 and an axle 322 orthogonally installed on and passing through the scroll wheel 320. The computer mouse 3 of the present invention is characterized by a supporting component 34, installed on an inner surface of the upper cover 30, with the supporting component 34 touching and supporting the axle 322.

As illustrated in FIG. 3A, the supporting component 34 comprises two straight brackets parallel to each other and stretching downward. Each of the brackets includes an opening 340 for an end of the axle 322 to pass through, such that the two straight brackets can fix and support the two ends of the axle 322 respectively, as illustrated in FIG. 3B. Moreover, the computer mouse 3 of the present invention can further include an optical sensor 36 installed at the two sides of the bottom of the scroll wheel 320, wherein the scroll wheel 320 is a lattice wheel structure as demonstrated in FIG. 3A.

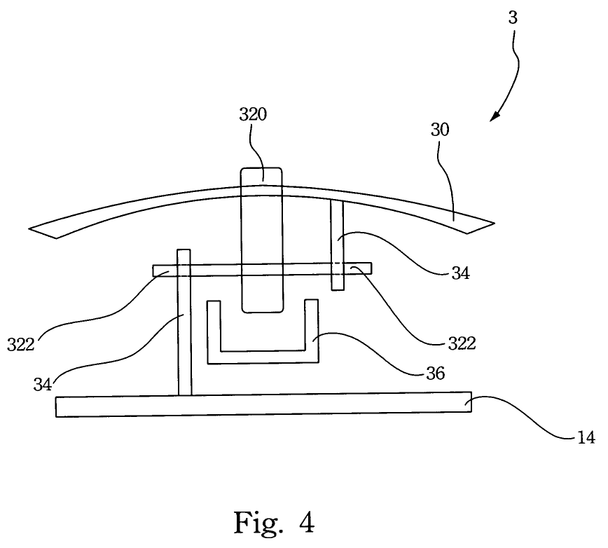

Furthermore, the present invention can include other embodiments in which the two straight brackets 34, parallel to each other and stretching downward, are installed in a different way. As illustrated in FIG. 4, there can be only one straight bracket 34 installed on the inner surface of the upper cover 30 and stretches downward, while the other straight bracket 34 is installed on an inner surface of a base 14 of the computer mouse and stretches upward oppositely.

In the computer mouse of the present invention, the supporting component for supporting the scroll wheel is installed on the upper surface of the upper cover of the mouse, which is not a common place to be used in the prior art. Hence the limited space of the mouse is utilized more efficiently, and the place of the base of the present computer mouse is saved for installing other electronic components. This is the advantage and contribution introduced the present invention.

Although the present invention has been described in considerable detail with reference to certain preferred embodiments thereof, other embodiments are possible. Therefore, their spirit and scope of the appended claims should no be limited to the description of the preferred embodiments contained herein.

It will be apparent to those skilled in the art that various modifications and variations can be made to the structure of the present invention without departing from the scope or spirit of the invention. In view of the foregoing, it is intended that the present invention covers modifications and variations of this invention provided they fall within the scope of the following claims and their equivalents.

What is claimed is:

1. A computer mouse, comprising:
an upper cover; and
a scroll wheel module, comprising:
a scroll wheel;
an axle orthogonally installed on and passing through the scroll wheel; and
a supporting component, installed on an inner surface of the upper cover, and touching and supporting the axle.

2. The computer mouse of claim 1, wherein the supporting component is a supporting frame with a shape of L in a lateral view having two racks to fix and support two ends of the axle respectively.

3. The computer mouse of claim 2, wherein each of the racks of the supporting frame comprises an opening for each of the two ends of the axle to pass through.

4. The computer mouse of claim 1, wherein the supporting component comprises two straight brackets parallel to each other and stretching downward, fixing and supporting two ends of the axle respectively.

5. The computer mouse of claim 4, wherein each of the straight brackets comprises an opening for each of the two ends of the axle to pass through.

6. The computer mouse of claim 1, wherein the scroll wheel is a lattice wheel structure.

7. The computer mouse of claim 6, further comprising: an optical sensor installed at two sides of the bottom of the scroll wheel.

8. The computer mouse of claim 1, wherein the supporting component comprises two straight brackets, wherein one straight bracket is installed on an inner surface of the upper cover and stretches downward, while the other straight bracket is installed on an inner surface of a base and stretches upward oppositely.
